(19) United States
(12) Patent Application Publication
(10) Pub. No.: US 2003/0191023 A1
(43) Pub. Date: Oct. 9, 2003

(54) Thermosensitive recording material

(75) Inventors: Satoshi Higuchi, Shizuoka-ken (JP); Shunsaku Higashi, Shizuoka-ken (JP); Hisahiro Mori, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/379,081

(22) Filed: Mar. 5, 2003

(30) Foreign Application Priority Data
Mar. 5, 2002 (JP) 2002-58952

(51) Int. Cl. B41M 5/30

(52) U.S. Cl. 503/216

(57) ABSTRACT

The present invention provides a thermosensitive recording material comprising a support and a thermosensitive recording layer containing, as color forming components, an electron donating dye precursor encapsulated in microcapsules and an electron accepting compound, the electron accepting compound containing a salicylic acid metal salt represented by the following General Formula (1):

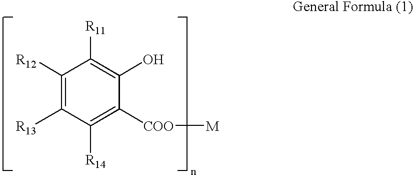

wherein R₁₁, R₁₂, R₁₃, and R₁₄ independently represent one of a hydrogen atom, a halogen atom, an alkyl group, an aryl group, an alkoxy group, an aryloxy group, an alkylthio group, an arylthio group, an alkylsulfonyl group, an arylsulfonyl group, an alkoxycarbonyl group, an aryloxycarbonyl group, an acyloxy group, an acyl group, a carbamoyl group, a sulfamoyl group, a sulfonamide group, a cyano group, and a nitro group; two adjacent groups in R₁₁, to R₁₄ may bond to each other to form a ring; M represents a metal ion having a valence of n; and n represents an integer of from 1 to 3.

### BACKGROUND OF THE INVENTION

1. Field of the Invention

The present invention relates to a thermosensitive recording material containing an electron donating dye precursor encapsulated in microcapsules and an electron accepting compound, and particularly to a thermosensitive material having superior color formation density and light fastness in image areas.

2. Description of the Related Art

Recording materials using an electron donating dye precursor and an electron accepting compound are already known as pressure sensitive papers, thermosensitive papers, photosensitive pressure sensitive papers, electro-thermosensitive recording papers, thermosensitive transfer papers, and the like. The details are disclosed in, for example, Great Britain Patent No. 2,140,449, U.S. Pat. Nos. 4,480,052 and 4,436,920, Japanese Patent Application Publication (JP-B) No. 60-23992, and Japanese Patent Application Laid-Open (JP-A) Nos. 57-179836, 60-123556 and 60-123557.

In particular, the details of thermosensitive recording materials are disclosed in JP-B Nos. 43-4160 and 45-14039.

These thermosensitive recording systems are applied in various fields including facsimiles, printers, and labels, and a need for there systems is spreading.

However, the thermosensitive recording materials has defects such that fogging is generated by a solvent, and the like and that color-forming components cause discoloration by oils and fats, chemicals, and the like. Accordingly, especially in fields of labels, vouchers, papers for word processor, papers for plotter, and the like, there is a problem in that the value of the commodity is lowered.

Thus, a mode for enhancing the preservability of images by encapsulating an electron donating dye precursor in microcapsules, thereby isolating an electron accepting compound from the dye in a recording layer has been proposed as one method for improving the preservability of the recording material (see JP-A Nos. 7-156551 and 10-114153 and Japanese Patent Application No. 2001-7955). With this mode, it is possible to obtain high color formation properties and image stability as compared with the case where the electron donating dye precursor is applied and dried as a solid dispersion.

However, according to the foregoing mode, not only is a high sensitivity not obtained unless the electron donating dye precursor is encapsulated in the proper capsules, but also increasing the color formation density in image areas of the recording material is incompatible with increasing the light fastness in the image areas. Accordingly, further improvements have been demanded.

### SUMMARY OF THE INVENTION

The present invention is to solve the above described various problems of the related art and to achieve the following object. That is, an object of the invention is to provide a thermosensitive recording material having superior color formation density and light fastness in image areas.

The invention relates to a thermosensitive recording material comprising a support and a thermosensitive recording layer containing, as color forming components, an electron donating dye precursor encapsulated in microcapsules and an electron accepting compound, the electron accepting compound containing a salicylic acid metal salt represented by the following General Formula (1):

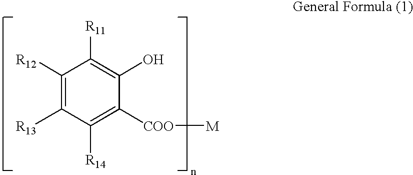

wherein R₁₁, R₁₂, R₁₃, and R₁₄ independently represent one of a hydrogen atom, a halogen atom, an alkyl group, an aryl group, an alkoxy group, an aryloxy group, an alkylthio group, an arylthio group, an alkylsulfonyl group, an arylsulfonyl group, an alkoxycarbonyl group, an aryloxycarbonyl group, an acyloxy group, an acyl group, a carbamoyl group, a sulfamoyl group, a sulfonamide group, a cyano group, and a nitro group; two adjacent groups in R₁₁ to R₁₄ may bond to each other to form a ring; M represents a metal ion having a valence of n; and n represents an integer of from 1 to 3.

### DETAILED DESCRIPTION OF THE PREFERRED EMBODIMENTS

The thermosensitive recording material according to the present invention comprises a thermosensitive recording layer on a support. The thermosensitive recording layer may be a layer or layers. If desired, the thermosensitive recording layer may further have other layer such as a protective layer.

The thermosensitive recording material according to the invention will be described below in detail.

In the thermosensitive recording material according to the invention, the thermosensitive recording layer contains an electron donating dye precursor encapsulated in microcapsules and an electron accepting compound as color-forming components, and contains a salicylic acid metal salt represented by the following General Formula (1). In the invention, when the salicylic acid metal salt represented by the following General Formula (1) is contained in a system containing microcapsules encapsulating therein an electron donating dye precursor as described later, it is possible to realize both high color formation density and superior light fastness.

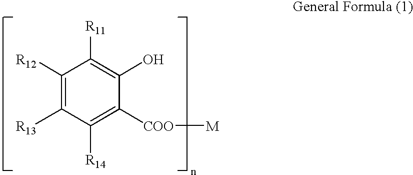

In the General Formula (1), R₁₁, R₁₂, R₁₃, and R₁₄ independently represent a hydrogen atom, a halogen atom, an alkyl group, an aryl group, an alkoxy group, an aryloxy group, an alkylthio group, an arylthio group, an alkylsulfonyl group, an arylsulfonyl group, an alkoxycarbonyl group, an aryloxycarbonyl group, an acyloxy group, an acyl group, a carbamoyl group, a sulfamoyl group, a sulfonamide group, a cyano group, or a nitro group; two adjacent groups among R₁₁ to R₁₄ may bond to each other to form a ring; M represents a metal ion having a valence of n; and n represents an integer of from 1 to 3.

Preferable examples of R₁₁, R₁₂, R₁₃, and R₁₄ include a chlorine atom, a methyl group, a t-butyl group, an n-hexyl group, a 3-heptyl group, a 2-ethylhexyl group, a 2,4,4-trimethylpentyl group, a 3,5,5-trimethylhexyl group, an n-dodecyl group, a cyclohexyl group, a cyclopentyl group, a benzyl group, an α-methylbenzyl group, an α,α-dimethylbenzyl group, a 2-chloroethyl group, a 2-ethoxyethyl group, a 2-(2,5-di-t-amylphenoxy)ethyl group, a 2-benzolyloxyethyl group, a phenyl group, a 4-methylphenyl group, a 2-chlorophenyl group, a methoxy group, a t-butyloxy group, a 2-ethylhexyloxy group, a 3,5,5-trimethylhexyloxy group, a cyclohexyloxy group, a phenoxy group, a 4-methylphenoxy group, a 2-methylphenoxy group, a 2-chlorophenoxy group, a methylthio group, an ethylthio group, a t-butylthio group, an n-octylthio group, a 2-ethylhexylthio group, a phenylthio group, a methylsulfonyl group, an n-butylsulfonyl group, a 2-ethylhexylsulfonyl group, an n-dodecylsulfonyl group, a phenylsulfonyl group, a 4-methylphenylsulfonyl group, a methoxycarbonyl group, an ethoxycarbonyl group, an n-propyloxycarbonyl group, an isopropyloxycarbonyl group, an n-butyloxycarbonyl group, a t-butyloxycarbonyl group, a phenoxycarbonyl group, a 4-methylphenoxycarbonyl group, a 2-chlorophenoxycarbonyl group, a propanoyloxy group, a butanoyloxy group, a 2-ethylhexanoyloxy group, an acetyl group, a butanoyl group, a hexanoyl group, an N,N-dimethylcarbamoyl group, an N,N-dibutylcarbamoyl group, an N,N-dimethylsulfamoyl group, a methanesulfonamide group, a butanesulfonamide group, a cyano group, and a nitro group.

Among these, alkyl groups having from 4 to 30 carbon atoms, an α-methylbenzyl group, and an α,α-dimethylbenzyl group are more preferable, and a t-butyl group, a cyclohexyl group, a 2,4,4-trimethylpentyl group, a dodecyl group, an α-methylbenzyl group, and an α,α-dimethylbenzyl group are particularly preferable.

In the foregoing General Formula (1), M represents a metal ion having a valence of n, and preferable examples thereof include ions of typical metals such as magnesium, calcium, aluminum, and tin, and ions of transition metals such as titanium, vanadium, chromium, manganese, iron, cobalt, nickel, copper, and zinc. Among these, a zinc ion and an aluminum ion are more preferable, and a zinc ion is particularly preferable.

Further, n represents an integer of from 1 to 3.

Specific examples of the salicylic acid metal salt include, but are not limited to, zinc 3,5-di-t-butylsalicylate, zinc 3-phenyl-5-(α,α-dimethylbenzyl) salicylate, zinc 3-cumyl-5-t-octylsalicylate, zinc 3,5-di-t-butylsalicylate, zinc 3-phenyl-5-t-octylsalicylate, zinc 3-methyl-5-α-methylbenzylsalicylate, zinc 3-methyl-5-cumylsalicylate, zinc 3,5-di-t-octylsalicylate, zinc 3,5-bis(a-methylbenzyl)salicylate, zinc 3-cumyl-5-phenylsalicylate, zinc 5-n-octadecylsalicylate, zinc 4-pentadecylsalicylate, zinc 3,5-bis(α,α-dimethylbenzyl)salicylate, zinc 3,5-bis-t-octylsalicylate, zinc 4-β-dodecyloxyethoxysalicylate, zinc 4-methoxy-6-dodecyloxysalicylate, zinc 4-β-phenoxyethoxy-salicylate, zinc 4-β-p-ethylphenoxyethoxysalicylate, and zinc 4-β-p-methoxyphenoxyethoxysalicylate.

These salicylic acid metal salts may be used alone or in combination.

The salicylic acid metal salt may be solid dispersed using a water-soluble polymer as a protective colloid by, for example, a sand mill, or may be emulsified and dispersed by dissolving in an organic solvent which hardly dissolve or does not dissolve in water and dispersing the resultant solution in water. Alternatively, the salicylic acid metal salt may be encapsulated in microcapsules.

In the invention, it is preferable that the salicylic acid metal salt is solid-dispersed in the thermosensitive recording layer.

In the invention, as the electron accepting compound, the salicylic acid metal salt may be used in combination with a known electron accepting compound such as phenol compounds, triphenylmethane compounds, sulfur-containing phenolic compounds, carboxylic acid compounds, sulfone compounds, ureas, and thiourea compounds.

Specific examples thereof include 4-t-butylphenol, 4-phenylphenol, 2,2′-dihydroxybiphenyl, bisphenol A, 4,4′-s-butylidenediphenol, 4,4′-cyclohexylidenediphenol, bis(3-allyl-4-hydroxyphenyl) sulfone, 4-hydroxyphenyl-3′,4′-dimethylphenyl sulfone, 4-(4′-iso-propoxyphenylsulfonyl)phenol, 4,4′-dihydroxydiphenyl sulfide, 1,4-bis-(4′-hydroxycumyl)benzene, 1,3-bis-(4′-hydroxycumyl)benzene, 4,4′-thiobis(6-t-butyl-3-methylphenol), 4,4′-dihydroxydiphenyl sulfone, benzyl 4-hydroxybenzoate, 3,5-di-t-butylsalicylic acid, 3-phenyl-5-(α,α-dimethylbenzyl) salicylic acid, 3-cumyl-5-t-octylsalicylic acid, 3-phenyl-5-t-octylsalicylic acid, 3-methyl-5-α-methylbenzylsalicylic acid, 3-methyl-5-cumylsalicylic acid, 3,5-di-t-octylsalicylic acid, 3,5-bis (α-methylbenzyl)salicylic acid, 3-cumyl-5-phenylsalicylic acid, and 5-n-octadecylsalicylic acid.

These known electron accepting compounds may be used in admixture of two or more thereof.

In the case where the salicylic acid metal salt and the known electron accepting compound are used in combination, an amount of the known electron accepting compound to be mixed is preferably from 10 to 100 parts by mass based on 100 parts by mass of the salicylic acid metal salt.

In the invention, a total content of the electron accepting compound is preferably from 0.5 to 50 parts by mass, and more preferably from 1 to 20 parts by mass per part by mass of the electron donating dye precursor as described later.

Next, the electron donating dye precursor and the microcapsules encapsulating the electron donating dye precursor therein will be described.

First of all, the microcapsules will be described in detail.

The microcapsules that are used in the invention are preferably those prepared by emulsifying core substances containing an electron donating dye precursor and then forming a wall made of a polymer substance in the surrounding of the oil droplet to achieve micro-encapsulation. In this case, a reactant to form the polymer substance is added to an inner portion of the oil droplet and/or an outer portion of the oil droplet. The details regarding the microcapsules that can be preferably used in the invention, including a preferable production method of the microcapsules, are disclosed in, for example, JP-B Nos. 4-37796 and 4-37797. Further, microcapsules not substantially encapsulating an organic solvent therein can be used.

The organic solvent that is used for forming the oil droplet can be properly selected from those generally used as a pressure sensitive oil. Preferable examples of the oil include alkylated naphthalenes, alkylated biphenyls, alkylated terphenyls, and diarylethanes. The oil may be used alone or in admixture of two or more thereof. The oil may be used in combination of other oil.

Examples of the capsule wall component of the microcapsules in the invention include polyurethanes, polyureas, polyamides, polyesters, polycarbonates, urea-formaldehyde resins, melamine resins, polystyrenes, styrene-methacrylate copolymers, gelatin, polyvinylpyrrolidone, and polyvinyl alcohol. Among these, polymer substances, polyurethanes, polyureas, polyamides, polyesters, and polycarbonates are preferable.

In particular, in the invention, those containing a polymer formed by polymerization of an isocyanate compound are preferable as the capsule wall component. Above all, when a polymer formed by polymerizing an isocyanate compound represented by the following General Formula (2) is used as the capsule wall component, an highly good color formation density can be achieved.

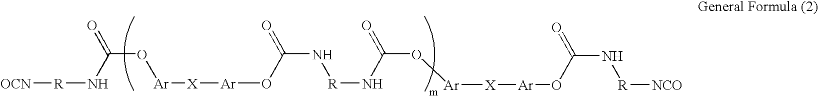

In the General Formula (2), Ar represents an arylene group; X represents a single bond or a divalent connecting group; R represents an alkylene group, an aralkylene group, or an arylene group; and m represents an integer of from 0 to 20.

In the General Formula (2), the arylene group represented by Ar may have a substituent. Specific examples of the arylene group include the following compounds.

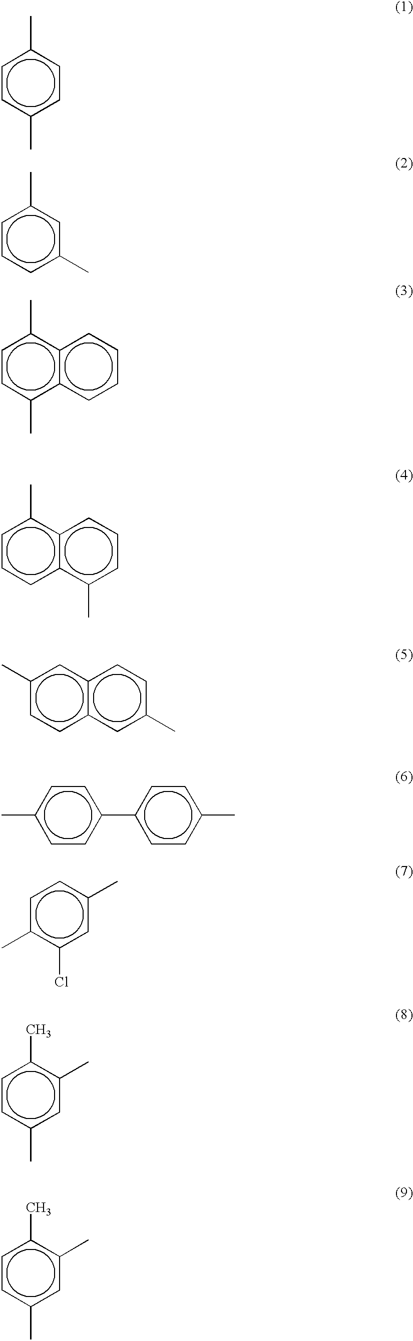

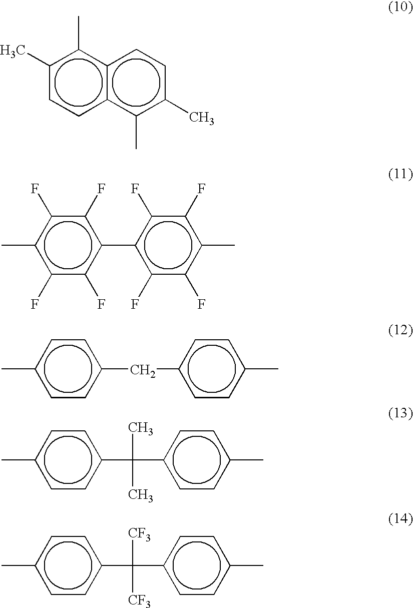

Among the arylene groups represented by Ar, those having a substituted or unsubstituted benzene ring in the structure thereof are preferable.

In the General Formula (2), specific examples of the single bond or divalent connecting bond represented by X include —O—, —SO₂—, —SO—, —S—, —CO—, —COO—, —CONH—, —SO₂NH—, a substituted or un-substituted alkylene group, a substituted or unsubstituted aralkylene group, a substituted or unsubstituted alkylidene group, a substituted or unsubstituted cycloalkylidene group, a substituted or unsubstituted arylene group, a substituted or unsubstituted oxyalkylene group, a substituted or unsubstituted oxyarylene group, a substituted or unsubstituted oxyaralkylene group, and a —COY—Z—YOC— group (wherein Y represents —O— or —NH—, and Z represents a substituted or unsubstituted alkylene group, a substituted or unsubstituted arylene group, or a substituted or unsubstituted aralkylene group).

Among the single bond or divalent connecting groups represented by X, —O—, —SO₂—, —SO—, —S—, —CO—, —COO—, an alkylene group having from 1 to 18 carbon atoms, an alkylidene group having from 2 to 18 carbon atoms, a cycloalkylidene group having from 5 to 12 carbon atoms, an arylene group having from 6 to 20 carbon atoms, an aralkylene group having from 7 to 18 carbon atoms, and —COO(CH₂)ₙOOC— (wherein n represents an integer of from 1 to 12) are preferable.

In the General Formula (2), the alkylene group represented by R may further have a substituent. Specific examples of the alkylene group include the following compounds.

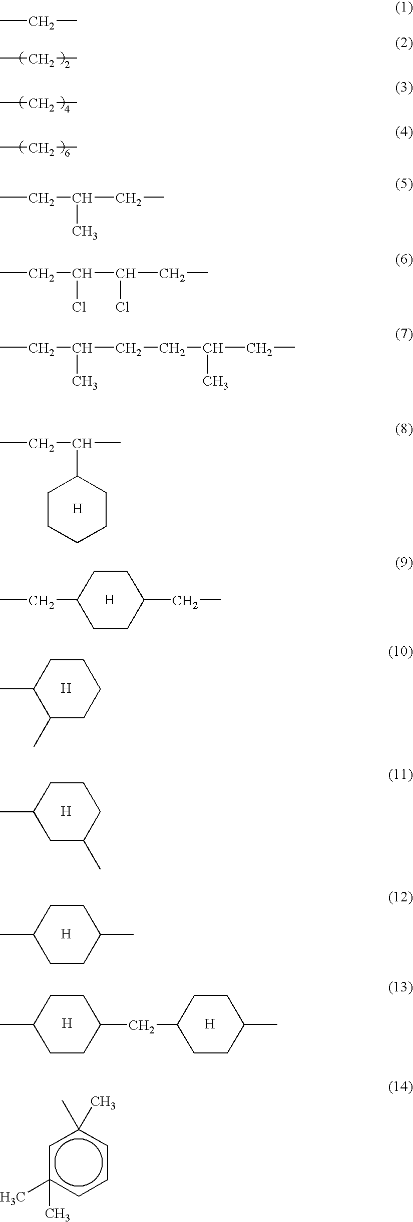

In the General Formula (2), the arylene group represented by R may further have a substituent. Specific examples of the arylene group include the following compounds.

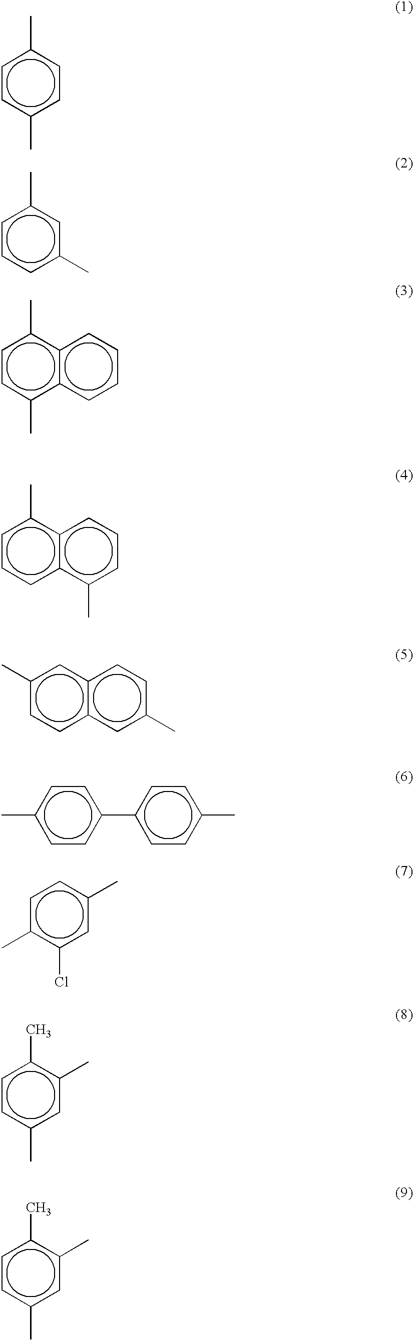

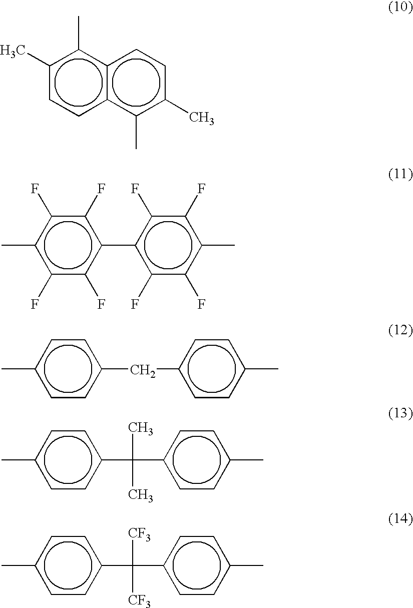

In the General Formula (2), the aralkylene group represented by R may further have a substituent. Specific examples of the aralkylene group include the following compounds.

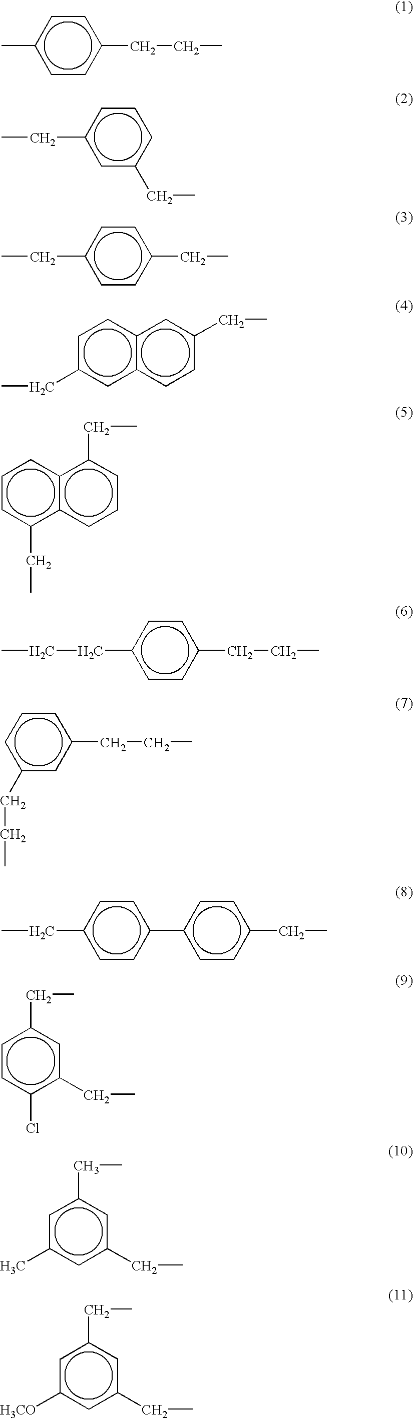

In the General Formula (2), the group represented by R is preferably an aralkylene group having from 8 to 18 carbon atoms.

In the General Formula (2), m represents an integer of from 0 to 20, preferably from 0 to 8, and more preferably from 0 to 4.

The synthesis of the compound represented by the General Formula (2), i.e., a bifunctional isocyanate compound having two isocyanate groups in one molecule, is a urethane bond-forming reaction by the addition of hydroxyl groups of a bisphenol compound to isocyanate groups of an isocyanate compound. General synthesis methods of urethane compounds can be used as such a synthesis reaction.

In the synthesis, the isocyanate compound may be reacted in an excessive molar amount to the bisphenol compound such that the terminals of the resultant compound are isocyanate groups. An amount of the isocyanate compound to be used is preferably from 2 to 8 times, and particularly preferably from 2 to 4 times as many as that of the bisphenol compound.

In the invention, the compound represented by the General Formula (2) is obtained by, for example, addition reaction of a compound represented by the following General Formula (4) and a compound represented by the following General Formula (5).

HO—Ar—X—Ar—OH General Formula(4)

In the General Formula (4) , Ar represents a substituted or unsubstituted arylene group, and X represents a single bond or a divalent connecting group.

OCN—R—NCO General Formula (5)

In the General Formula (5) , R represents a substituted or unsubstituted alkylene group, a substituted or unsubstituted aralkylene group, or a substituted or unsubstituted arylene group.

Specific examples of the compound (bisphenol compound) represented by the General Formula (4) include, but are not limited to, bis(4-hydroxyphenyl) ether, 4-hydroxyphenoxy-3′-phenol, 4-hydroxy-3-methylphenylcarbonyl-4′-phenol, bis(4-hydroxyphenyl) sulfone, bis(4-hydroxynaphthyl) sulfone, bis(4-hydroxyphenyl) sulfoxide, bis(4-hydroxy-3-chlorophenyl) sulfide, bis(4-hydroxyphenyl) ketone, N-(3′-hydroxyphenyl)-4-hydroxybenzoic acid amide, N-(2′-hydroxyphenyl)-4-hydroxyphenylsulfonamide, bis(4-hydroxyphenyl) methane, 1,2-bis(4-hydroxyphenyl)ethane, bis(4-hydroxyphenyl)-m-xylylene, bis(4-hydroxyphenyl)-p-xylylene, 2,2-bis(4-hydroxyphenyl)propane, 2,2-bis(4-hydroxy-3,5-dichlorophenyl)propane, 2,2-bis(4-hydroxy-3-methylphenyl)propane, 2,2-bis(4-hydroxy-3-phenyl-phenyl) propane, 2,2-bis(4-hydroxyphenyl)hexafluoropropane, 2,2-bis(4-hydroxyphenyl)butane, 2,2-bis(4-hydroxyphenyl)-isopentane, 1,1-bis(4-hydroxyphenyl)-1-phenylethane, 3,3-bis (4-hydroxyphenyl)-1-phenylpropane, bis(4-hydroxy-phenyl) cyclohexylmethane, 1,1-bis(4-hydroxyphenyl)-2-ethylhexane, 1,1-bis(4-hydroxyphenyl)cyclopentane, 1,1-bis (4-hydroxyphenyl)cyclohexane, 2,2-bis(2-hydroxyphenyl)-propane, 1,4-bis(3-hydroxyphenoxy)butane, bis(4-hydroxy-phenoxy) -m-xylylene, 1,3-bis(4-hydroxy-3-methylphenoxy) -5-methylphenylene, 1,5-bis(4-hydroxyphenylcarboxyl)pentane, 1,6-bis(4-hydroxybenzoylamino)hexane, and bis(4-hydroxy-3-isopropylphenyl) sulfone.

Specific examples of the compound (isocyanate compound) represented by the General Formula (5) include, but are not limited to, m-phenylene diisocyanate, p-phenylene diisocyanate, 2,6-tolylene diisocyanate, 2,4-tolylene diisocyanate, naphthalene-1,4-diisocyanate, diphenyl-methane-4,4′-diisocyanate, 3,3′-dimethoxy-biphenyl diisocyanate, 3,3′-dimethyldiphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, 4,4′-diphenylpropane diisocyanate, 4,4′-diphenylhexafluoropropane diisocyanate, trimethylene diisocyanate, hexamethylene diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexyl-methane-4,4′-diisocyanate, 1,4-bis(isocyanatomethyl)-cyclohexane, and 1,3-bis(isocyanatemethyl)cyclohexane.

In the invention, specific examples of a polyfunctional isocyanate compound having three or more isocyanate groups in one molecule, as the capsule wall component of the microcapsules, which can be used in combination with the compound represented by the General Formula (2) include polyfunctionalized adducts of a trimer (a biuret or an isocynurate) comprised of, as a major raw material, a diisocyanate (such as xylene diisocyanate and its hydrogenation products, hexamethylene diisocyanate, tolylene diisocyanate and its hydrogenation products, and isophorone diisocyanate) with a polyol (such as trimethyloypropane), and formalin condensates of benzene isocyanate. The details of these materials are described in Keiji Iwata ed., Polyurethane Resin Handbook, published by The Nikkan Kogyo Shimbun, Ltd. (1987).

In the invention, a size of the microcapsules is preferably 4 μm or less, and more preferably from 0.5 μm to 2 μm in terms of a volume average particle size by the measurement method as disclosed in, for example, JP-A No. 60-214990.

The thus produced preferable microcapsules are not those to be broken by heat or pressure as used in the conventional recording materials, but the reactive substances contained in the core and outside of the microcapsules can penetrate the microcapsule wall and can react with each other.

In the invention, by properly selecting the capsule wall components of the microcapsules and optionally adding a glass transition point regulating agent (such as the plasticizer as disclosed in JP-A No. 61-277490) thereto, microcapsules made of walls having a different glass transition point are prepared, and combinations of one of the electron donating dye precursors having different hues with a proper electron accepting compound are selected, whereby various colors can be realized.

Accordingly, the invention is not limited to a monochromic thermosensitive recording material and can be applied to a thermosensitive recording material suitable for two-color or multi-color formation. Further, if desired, a light fading inhibitor as disclosed in, for example, JP-A Nos. 61-283589, 61-283590 and 61-283591 can be properly added to the thermosensitive recording material.

Next, the electron donating dye precursor in the invention will be described in detail.

In the inventin, the electron donating dye precursor that are colorless or monochromic may properly be selected from known compounds that donate an electron or accept a proton of, e.g., an acid to form a color. These compounds have a partial skeleton such as lactone, lactam, spiropyran, ester, and amide and when brought into contact with an electron accepting compound, the partial skeleton opens or cleaves. Preferable examples of the compounds include triphenylmethane phthalide compounds, fluoran compounds, phenothiazine compounds, indolylphthalide compounds, leucoauramine compounds, rhodamine lactam compounds, triphenylmethane compounds, triazene compounds, spiropyran compounds, and fluorene compounds. Specific examples of phthalides are disclosed in U.S. Reissue Pat. No. 23,024, U.S. Pat. Nos. 3,491,111, 3,491,112, 3,491,116 and 3,509,174, and JP-A Nos. 9-118073 and 9-118073; specific examples of fluorans are disclosed in U.S. Pat. Nos. 3,624,107, 3,627,787, 3,641,011, 3,462,828, 3,681,390, 3,920,510 and 3,959,571; specific examples of spiropyrans are disclosed in U.S. Pat. No. 3,971,808; specific examples of pyridines and pyrazines are disclosed in U.S. Pat. Nos. 3,775,424, 3,853,869 and 4,246,318; and specific examples of fluorenes are disclosed in Japanese Patent Application No. 61-240989, respectively.

In the invention, the electron donating dye precursor is particularly preferably a compound represented by the following General Formula (3).

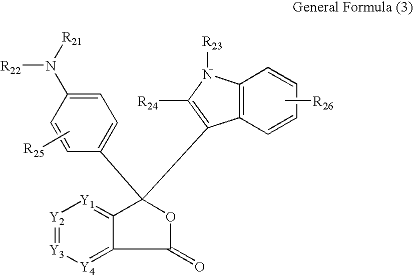

In the General Formula (3), R₂₁ and R₂₂ independently represent a hydrogen atom, an alkyl group, a cycloalkyl group, an aralkyl group, or an aryl group, provided that R₂₁ and R₂₂ do not represent a hydrogen atom simultaneously; R₂₃ represents a hydrogen atom, an alkyl group, a cycloalkyl group, an aralkyl group, or an aryl group; R₂₄ represents a hydrogen atom, an alkyl group, or an aryl group; R₂₅ and R₂₆ independently represent a hydrogen atom, an alkyl group, an alkoxy group, an amide group, an alkylamide group, or a halogen atom; and one or two of Y₁, Y₂, Y₃, and Y₄ represent ═N—, and the others represent ═CH—.

R₂₁ and R₂₂ are preferably, an alkyl group having from 1 to 18 carbon atoms, a cycloalkyl group having from 4 to 12 carbon atoms, an aralkyl group having from 7 to 18 carbon atoms, or an aryl group having from 6 to 20 carbon atoms and are more preferably an alkyl group having from 1 to 12 carbon atoms, a cycloalkyl group having from 5 to 6 carbon atoms, an aralkyl group having from 7 to 12 carbon atoms, or an aryl group having from 6 to 12 carbon atoms. These groups may be further substituted with, for example, an alkyl group having from 1 to 8 carbon atoms, an alkoxy group having from 1 to 8 carbon atoms, an aryl group having from 6 to 10 carbon atoms, an aryloxy group having from 6 to 10 carbon atoms, or a halogen atom.

Specific and preferable examples of R₂₁ and R₂₂ include a methyl group, an ethyl group, an n-propyl group, an isopropyl group, an n-butyl group, an isobutyl group, a sec-butyl group, an n-pentyl group, an isopentyl group, an n-hexyl group, an n-octyl group, a 2-ethylhexyl group, an n-decyl group, an n-dodecyl group, a cyclopentyl group, a cyclohexyl group, a benzyl group, a 2-phenethyl group, a 1-phenethyl group, a phenyl group, a p-tolyl group, a p-methoxyphenyl group, a p-chlorophenyl group, a 2-methoxyethyl group, a 2-(2-methoxyethoxy) ethyl group, a 2-phenoxyethyl group, a 2-phenoxypropyl group, and a 3-phenoxypropyl group.

R₂₁ and R₂₂ may bond to each other to form a cyclic amino structure. Specific examples of the cyclic amino structure include a 1-pyrrolidinyl group, a piperidylino group, and a morpholino group.

R₂₃ represents a hydrogen atom, an alkyl group, a cycloalkyl group, an aralkyl group, or an aryl group. R₂₃ preferably represents an alkyl group having from 1 to 20 carbon atoms, a cycloalkyl group having from 6 to 20 carbon atoms, an aralkyl group having from 7 to 20 carbon atoms, or an aryl group having from 6 to 20 carbon atoms; and more preferably represents an alkyl group having from 1 to 12 carbon atoms, a cycloalkyl group having from 6 to 12 carbon atoms, an aralkyl group having from 7 to 12 carbon atoms, or an aryl group having from 6 to 12 carbon atoms.

Specific and preferable examples of R₂₃ include a hydrogen atom, a methyl group, an ethyl group, an n-propyl group, an isopropyl group, an n-butyl group, an isobutyl group, a sec-butyl group, an n-pentyl group, an isopentyl group, an n-hexyl group, an n-octyl group, a 2-ethylhexyl group, an n-decyl group, an n-dodecyl group, a cyclopentyl group, a cyclohexyl group, a benzyl group, a 2-phenethyl group, a 1-phenethyl group, a phenyl group, a p-tolyl group, a p-methoxyphenyl group, a p-chlorophenyl group, a 2-methoxyethyl group, a 2-(2-methoxyethoxy)ethyl group, a 2-phenoxyethyl group, a 2-phenoxypropyl group, a 3-phenoxypropyl group, and a 2-chloroethyl group.

R₂₄ represents a hydrogen atom, an alkyl group, or an aryl group. R₂₄ preferably represents a hydrogen atom, an alkyl group having from 1 to 18 carbon atoms, or an aryl group having from 6 to 15 carbon atoms and more preferably represents an alkyl group having from 1 to 12 carbon atoms or an aryl group having from 6 to 10 carbon atoms. These groups may be further substituted with, for example, an alkyl group having from 1 to 8 carbon atoms, an alkoxy group having from 1 to 8 carbon atoms, an aryl group having from 6 to 10 carbon atoms, an aryloxy group having from 6 to 10 carbon atoms, or a halogen atom.

Specific and preferable examples of R₂₄ include a hydrogen atom, a methyl group, an ethyl group, an n-propyl group, an isopropyl group, an n-butyl group, an isobutyl group, a sec-butyl group, an n-pentyl group, an isopentyl group, an n-hexyl group, an n-octyl group, a 2-ethylhexyl group, an n-decyl group, an n-dodecyl group, a cyclopentyl group, a cyclohexyl group, a benzyl group, a 2-phenethyl group, a 1-phenethyl group, a phenyl group, a p-tolyl group, a p-methoxyphenyl group, a p-chlorophenyl group, a 2-methoxyethyl group, a 2-(2-methoxyethoxy) ethyl group, a 2-phenoxyethyl group, a 2-phenoxypropyl group, a 3-phenoxypropyl group, and a 2-chloroethyl group.

R₂₅ and R₂₆ independently represent a hydrogen atom, an alkyl group, an alkoxy group, an amide group, an alkylamide group, or a halogen atom, and preferably represents a hydrogen atom, an alkyl group having from 1 to 4 carbon atoms, an alkoxy group having from 1 to 4 carbon atoms, an alkylamide group having from 1 to 4 carbon atoms, or a chlorine atom. Specific and preferable examples of R₂₅ and R₂₆ include a hydrogen atom, a methyl group, an isopropyl group, a methoxy group, an ethoxy group, an acetylamide group, and a chlorine atom.

One or two of Y₁, Y₂, Y₃, and Y₄ represent ═N—, and the others represent ═CH—. In the General Formula (3), in the case where two of Y₁, Y₂,Y₃, and Y₄ represent ═N—, it is preferable that Y₁ and Y₄ represent ═N—.

In the General Formula (3) , in the case where Y₁, Y₂, Y₃, and/or Y₄ represent ═CH—, the hydrogen atom of arbitrary ═CH— may be substituted with an alkyl group, an aryl group, or a halogen atom. A methyl group, an ethyl group, and a phenyl group are particularly preferable as the substituent.

Next, specific examples [(3)-1to (3)-25] of the compound represented by the General Formula (3) will be given below, but the invention is not limited thereto.

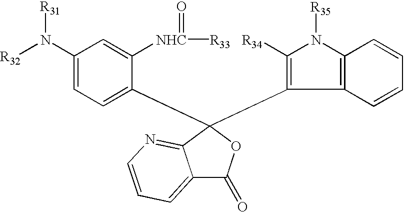

| | R₃₁ | R₃₂ | R₃₃ | R₃₄ | R₃₅ |
|---|---|---|---|---|---|
| (3)-1 | —CH₃ | —CH₃ | —CH₃ | —CH₃ | —C₂H₅ |
| (3)-2 | —CH₃ | —CH₃ | —CH₃ | —CH₃ | —C₈H₁₇(n) |
| (3)-3 | —C₂H₅ | —C₂H₅ | —CH₃ | —CH₃ | —C₂H₅ |
| (3)-4 | —C₂H₅ | —C₂H₅ | —C₂H₅ | —CH₃ | —C₂H₅ |
| (3)-5 | —C₂H₅ | —C₂H₅ | —C₃H₇(n) | —CH₃ | —C₂H₅ |
| (3)-6 | —C₂H₅ | —C₂H₅ | —C₃H₇(i) | —CH₃ | —C₂H₅ |
| (3)-7 | —C₂H₅ | —C₂H₅ | —C₄H₉(t) | —CH₃ | —C₂H₅ |
| (3)-8 | —C₂H₅ | —C₂H₅ | —C₅H₁₁(n) | —CH₃ | —C₂H₅ |
| (3)-9 | —C₂H₅ | —C₂H₅ | 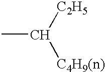 | —CH₃ | —C₂H₅ |
| (3)-10 | —C₂H₅ | —C₂H₅ | —CH₃ | —CH₃ | —C₈H₁₇(n) |
| (3)-11 | —C₂H₅ | —C₂H₅ | —CH₃ | —CH₃ | —C₅H₁₁(n) |
| (3)-12 | —C₂H₅ | —C₂H₅ | —CH₃ | 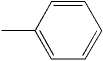 | —C₂H₅ |
| (3)-13 | —C₃H₇(n) | —C₃H₇(n) | —CH₃ | —CH₃ | —C₂H₅ |
| (3)-14 | —C₃H₇(n) | —C₃H₇(n) | —CH₃ | —CH₃ | —C₈H₁₇(n) |
| (3)-15 | —C₃H₇(n) | —C₃H₇(n) | —C₃H₇(n) | —CH₃ | —C₈H₁₇(n) |
| (3)-16 | —C₄H₉(n) | —C₄H₉(n) | —CH₃ | —CH₃ | —C₂H₅ |
| (3)-17 | —C₄H₉(n) | —C₄H₉(n) | —CH₃ | —CH₃ | —C₈H₁₇(n) |
| (3)-18 | —C₂H₅ | 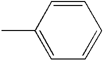 | —CH₃ | —CH₃ | —C₂H₅ |
| (3)-19 | —C₃H₇(i) | —C₃H₇(i) | —CH₃ | —CH₃ | —C₂H₅ |
| (3)-20 | —C₈H₁₇(n) | —C₈H₁₇(n) | —CH₃ | —CH₃ | —C₂H₅ |
| (3)-21 | —C₁₈H₃₇(n) | —C₁₈H₃₇(n) | —CH₃ | —CH₃ | —C₂H₅ |

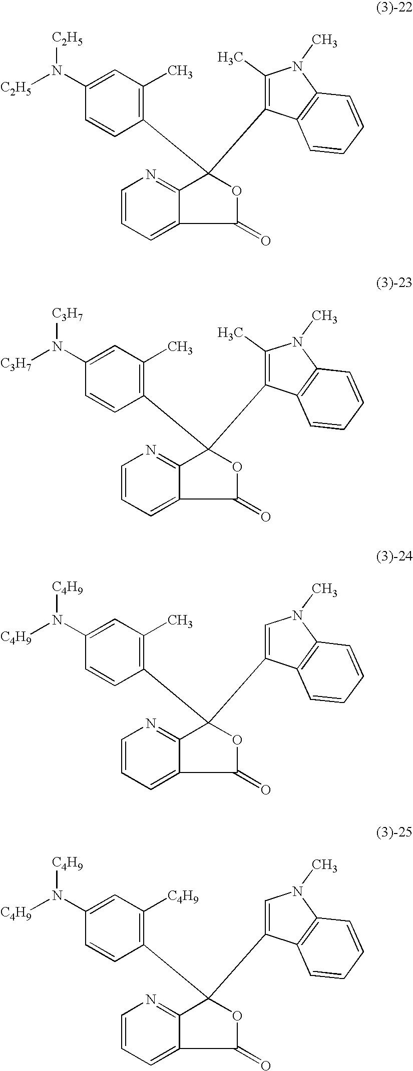

A content of the electron donating dye precursor is preferably from 0.1 to 2.0 g/m², and more preferably from 0.2 to 1.5 g/m² in one thermosensitive recording layer.

If desired, other components may be properly added to the thermosensitive recording material according to the invention.

In the thermosensitive recording material according to the invention, a UV absorbnt may be added for the purpose of improving the stability to light. Examples of the UV absorbent include cinnamic acid derivatives, benzophenone derivatives, and benzotriazolylphenol derivatives. Specific examples thereof include butyl α-cyano-β-phenylcinnamate, o-benzo-triazolephenol, o-benzotriazole-p-chlorophenol, o-benzo-triazole-2,4-di-t-butylphenol, and o-benzotriazole-2,4,-di-t-octylphenol. Phenol derivatives in which at least one of the 2- and 6-positions is substituted with a branched alkyl group are preferable as the hindered phenol compound. The UV absorbent can be used as a solid dispersion or emulsion, or in microcapsules. An amount of the UV absorbent to be used is preferably from 0.05 to 1.0 g/m², and more preferably from 0.1 to 0.4 g/m².

Known water-soluble polymer compound and latex can be used as a binder that is used in the thermosensitive recording material according to the invention. Examples of the water-soluble polymer compound include methyl cellulose, carboxymethyl cellulose, hydroxymethyl cellulose, starches, gelatin, gum arabic, casein, styrene-maleic anhydride copolymer hydrolyzates, ethylene-maleic anhydride copolymer hydrolyzates, polyvinyl alcohol, polyacrylamide, and modified products thereof. Examples of the latex include styrene-butadiene rubber latexes, acrylonitrile-butadiene rubber latexes, methyl acrylate-butadiene rubber latexes, and vinyl acetate emulsions. An amount of the binder to be used is preferably from 0.4 to 5 g/m², and preferably from 0.8 to 1.6 g/m².

In the thermosensitive recording material according to the invention, any known pigment can be used irrespective of organic or inorganic ones. Specific examples thereof include kaolin, calcined kaolin, talc, agalmatolite, diatomaceous earth, calcium carbonate, aluminum hydroxide, magnesium hydroxide, zinc oxide, lithopone, amorphous silica, colloidal silica, calcined gypsum, silica, magnesium carbonate, titanium oxide, alumina, barium carbonate, barium sulfate, mica, microballoon, urea-formalin fillers, polyester particles, and cellulose fillers.

In the invention, in order to improve the thermal responsiveness, a known sensitizer can be contained in the thermosensitive recording layer. Examples of the sensitizer include aromatic ethers, thioethers, esters, aliphatic amides, and ureides. The details of examples of these sensitizers are disclosed in, for example, JP-A Nos. 58-57989, 58-87094, 61-58789, 62-109681, 62-132674, 63-151478 and 63-235961. An amount of the sensitizer to be used is preferably from 1 to 10 g/m², and more preferably from 2 to 4 g/m².

If desired, any additive such as a known wax, an antistatic agent, an antifoaming agent, a conductive agent, a fluorescent dye, a surfactant, and a UV absorbent precursor can be used in the thermosensitive recording material according to the invention.

In addition to the thermosensitive recording layer containing the electron accepting compound and the salicylic acid metal salt represented by the General Formula (1), the thermosensitive recording material according to the invention may have other thermosensitive recording layer.

Other thermosensitive recording layer may contain a diazonium compound and a coupler that reacts with the diazonium compound to form a color. This thermosensitive recording layer may be a layer or layers.

In the invention, plural thermosensitive recording layers giving a different hue may be successively laminated to form a multi-color thermosensitive recording material.

In the invention, each of the thermosensitive recording layers and an optional protective layer can be formed by applying respective coating solutions successively to a support by known coating methods such as blade coating, air knife coating, gravure coating, roll coating, spray coating, dip coating, and bar coating, and drying coated layers.

In the thermosensitive recording material according to the invention, if desired, a protective layer may be provided on the thermosensitive recording layer. The protective layer may be made of a laminate of two or more layers, if desired.

Examples of the material that is used for the protective layer include water-soluble polymer compounds such as polyvinyl alcohol, carboxy-modified polyvinyl alcohol, vinyl acetate-acrylamide copolymers, silicon-modified polyvinyl alcohol, starches, modified starches, methyl cellulose, carboxymethyl cellulose, hydroxymethyl cellulose, gelatins, gum arabic, casein, styrene-maleic acid copolymer hydrolyzates, styrene-maleic acid copolymer half ester hydrolyzates, isobutylene-maleic anhydride copolymer hydrolyzates, polyacrylamide derivatives, polyvinyl-pyrrolidone, sodium polystyrenesulfonate, and sodium alginate; and latexes such as styrene-butadiene rubber latexes, acrylonitrile-butadiene rubber latexes, methyl acrylate-butadiene rubber latexes, and vinyl acetate emulsions. The water-soluble polymer compound in the protective layer can be crosslinked in order to more enhance the stability. A known crosslinking agent can be used for this purpose. Specific examples thereof include N-methylolurea, N-methylolmelamine, and water-soluble precondensates such as urea-formalin; dialdehyde compounds such as glyoxal and glutaraldehyde; inorganic crosslinking agents such as boric acid and borax; and polyamide epichlorohydrin. For the protective layer, a known pigment, a metallic soap, a wax, and a surfactant can be further used.

An application amount of the protective layer is preferably from 0.2 to 5 g/m², and more preferably from 0.5 to 2 g/M². A thickness of the protective layer is preferably from 0.2 to 5 μm, and more preferably from 0.5 to 2 μm.

The protective layer may contain a UV absorbent or a UV absorbent precursor.

Suitable examples of the support that can be used for the thermosensitive recording material according to the invention include acidic papers, neutral papers, coated papers, plastic-laminated papers, synthetic papers, and plastic films. Further, a known subbing layer may be provided on the support. The subbing layer can be provided by the layer formation method as described above.

In the invention, in order to correct the curling balance of the support or to enhance the chemical resistance from the back surface, a back coat layer may be provided on the support, or the support can be in the form of a label having release paper and an adhesive layer. The back coat layer can be provided by the layer formation method as described above.

The thermosensitive recording material according to the invention can be a multi-color thermosensitive recording material as described above.

The details of the multi-color thermosensitive recording material (photosensitive thermosensitive recording material) are disclosed in, for example, JP-A Nos. 4-135787, 4-144784, 4-144785, 4-194842, 4-247447, 4-247448, 4-340540, 4-340541 and 5-34860.

Concretely, the multi-color thermosensitive recording material can be obtained by laminating thermosensitive recording layers which form different colors. The layer configuration is not particularly limited. But, a multi-color thermosensitive recording material comprising a thermosensitive recording layer (layer B) comprising a combination of a diazonium compounds and a coupler which reacts with the diazonium compound when heated to form a color, a thermosensitive recording layer (layer C) comprising a combination of a diazonium having a different photosensitive wavelength and a coupler which reacts with this diazonium compound when heated to form a different color, and a thermosensitive recording layer comprising a combination of an electron donating colorless dye and an electron accepting compound is particularly preferable.

That is, a multi-color thermosensitive recording material comprising a first thermosensitive recording layer (layer A) containing an electron donating dye precursor and an electron accepting compound, a second thermosensitive recording layer (layer B) containing a diazonium compound having a maximum absorption wavelength of 360 nm±20 nm and a coupler which reads with the coupler when heated to form a color, and a third thermosensitive recording layer (layer C) containing a diazonium compound having a maximum absorption wavelength of 430 nm±30 nm and a coupler which reacts with this diazonium compound when heated to form a different color on a support is preferable. In this embodiment, when the hues of each of the thermosensitive recording layers are selected such that they become three primary colors in the subtractive mixing, namely yellow, magenta and cyan, it becomes possible to realize full-color image recoding.

The recording of the multi-color thermosensitive recording material is carried out in the following manner. First of all, the third thermosensitive recording layer (layer C) is heated to react the diazonium compound and the coupler contained therein and to form a color. Next, the recording material is exposed to light having a wavelength of 430 nm±30 nm to decompose the unreacted diazonium compound contained in the layer C, and then, a heat sufficient for color formation the second thermosensitive recording layer (layer B) is applied to the recording material, thereby reacting the diazonium compound and the coupler. At this time, though the layer C is simultaneously heated strongly, the diazonium compound contained in the layer C does not form a color because it has already decomposed and lost the color formation ability. Further, the recording material is exposed to light having a wavelength of 360 nm±20 nm to decompose the diazonium compound contained in the layer B, and finally, a heat sufficient for color formation of the first thermosensitive recording layer (layer A) is applied to the recording material, thereby causing color formation. At this time, though the layer C and the layer B are simultaneously heated strongly, the diazonium compounds do not form colors because they have already decomposed and lost the color formation ability.

It is preferable that the diazonium compound and the couplerontained in the photosensitive layer are used in a thermal development mode in which the both are brought into contact with each other by heating and reacts to form a color.

A photodecomposable compound that decomposes upon receiving light having a specific wavelength prior to the color development reaction is used as the diazonium compound. Here, the photodecomposable compound chiefly means an aromatic diazonium compound. More specifically, it means an aromatic diazonium salt compound, a diazosulfonate compound, or a diazoamino compound. In general, it is said that the photodecomposition wavelength of the diazonium compound is an absorption maximum wavelength thereof. Further, it is known that the absorption maximum wavelength of the diazonium compound changes from about 200 nm to about 700 nm depending on the chemical structure thereof [Takahiro Tsunoda and Tsuguo Yamaoka ed., Journal of Society of Photographic Science and Technology of Japan, “Photodecomposition and Chemical Structure of Photosensitive Diazonium Salt Compounds”, 29 (4), pp. 197-205 (1965)]. That is, when the diazonium compound is used as a photodecomposable compound, it is decomposed by light having a specific wavelength according to the chemical structure thereof. Further, by changing the chemical structure of the diazonium compound, even when it coupling-reacts with the same coupling component, it is possible to change the hue of the resultant dye.

Examples of the diazonium compound that is used in the invention include the compounds disclosed in JP-A Nos. 60-184880, 61-172789 and 2-147285, and Japanese Patent Application Nos. 5-297024, 5-122865 and 5-278608. Specific examples include 1-diazo-4-dimethylaminobenzene, 1-diazo-4-N-methyl-N-n-dodecylaminobenzene, 1-diazo-4-N-ethyl-N-n-dodecylaminobenzene, 1-diazo-4-morpholinobenzene, 1-diazo-4-methylbenzylaminobenzene, 1-diazo-4-N-ethyl-N-(2-hydroxyethyl)aminobenzene, 1-diazo-2-methoxy-4-diethylaminobenzene, 1-diazo-2-n-butoxy-4-di-n-butylaminobenzene, 1-diazo-2-n-hexyloxy-4-di-n-hexylaminobenzene, 1-diazo-2-n-octyloxy-4-di-n-octylaminobenzene, 1-diazo-2-n-hexyloxy-4-bis(2-cyanoethylamino)benzene, 1-diazo-2-n-hexyloxy-4-N-n-hexyl-N-(1-methyl-2-p-methoxyphenoxyethylamino)benzene, 1-diazo-2-(l-ethyl-propyloxy)-4-N,N-bis-(dibutylcarbamoylmethyl)benzene, 1-diazo-5-butoxy-2-chloro-4-dimethylaminobenzene, 1-diazo-5-methoxy-2-chloro-4-piperazinobenzene, 1-diazo-4-morpholino-2,5-dibutoxybezene, 1-diazo-4-pyrrolidino-3-methoxybenzene, 1-diazo-4-(2-ethylhexanoylpiperidino)-2,5-dibutoxybenzene, 1-diazo-4-[α-(2,4-di-t-amylphenoxy) butyrylpiperidino]benzene, 1-diazo-2-N,N-diethylcarbamoyl-5-ethoxy-4-diethylaminobenzene, 1-diazo-2-p-tolylthio-5-phenoxy-4-diethylaminobenzene, 4-diazo-4′-methoxystilbene, 1-diazo-4-p-tolylthio-2,5-diethoxybenzene, 1-diazo-4-p-tolylthio-2,5-di-n-butoxybenzene, 1-diazo-4-(p-chlorophenylthio)-2,5-di-n-butoxybenzene, 1-diazo-4-(p-chlorophenylthio)-2,5-di-n-pentyloxybenzene, 1-diazo-4- (4-methoxyphenylthio)-2,5-diethoxybenzene, 1-diazo-4-(N,N-dioctylaminocarbonyl)benzene, 1-diazo-4-(4-t-octylphenoxy)benzene, and 1-diazo-4-(4-methoxybenzamido)-2,5-diethoxybenzene.

Any acids that form a counter salt with the diazonium compound can be used as an acid which form a part of a diazonium compound. Among these, polyfluoroalkylcarboxylic acids having from 1 to 9 carbon atoms, polyfluoroalkylsulfonic acids having from 1 to 9 carbon atoms, boron tetrafluoride, tetraphenylboron, hexafluorophosphoric acid, aromatic carboxylic acids, and aromatic sulfonic acids are preferable. Among them, boron tetrafluoride, tetraphenylboron, and hexafluorophosphoric acid are particularly preferable. In addition, it is possible to stabilize the diazonium compound by making it form a complex compound with, for example, zinc chloride, cadmium chloride, or tin chloride.

The diazonium compound that is used in the invention may be used alone or in admixture of two or more thereof.

In the invention, it is possible to obtain a multi-color recording material by using diazonium compounds having a different photodecomposition wavelength or a different photodecomposition rate. Further, an amount of the diazonium compound is preferably from 0.05 to 5.0 g/m².

The compounds disclosed in JP-A Nos. 1-67379, 2-54250 and 4-53794, and Japanese Patent Application Nos. 6-18669 and 6-18670 are preferable as the coupler that can be used in the invention. Any compounds that coupling-react with the diazonium compound in a basic atmosphere to form a dye can be used as the coupling component that can be used in the invention.

Examples thereof include active methylene compounds having a methylene group adjacent to the carbonyl group, phenol derivatives, and naphthol derivatives. Specific examples thereof include resorcin, fluoroglucin, sodium 2,3-dihydroxynaphthalene-6-sulfonate, 1-hydroxy-2-naph-thoic acid morpholinopropylamide, 1,5-dihydroxynaphthalene, 2,3-dihydroxynaphthalene, 2,3-dihydroxy-6-sulfonyl-naphthalene, 2-hydroxy-3-naphthoic acid morpholino-propylamide, 2-hydroxy-3-naphthoic acid octylamide, 2-hydroxy-3-naphthoic acid anilide, 5,5-dimethyl-1,3-cyclohexanedione, 1,3-cyclopentanedione, 5-(2-tetra-decyloxyphenyl) -1,3-cyclohexanedione, 5-phenyl-4-methoxycarbonyl-1,3-cyclohexanedione, 5-(2,5-di-n-octyloxyphenyl)-1,3-cyclohexanedione, 1,3-di-cyclohexylbarbituric acid, 1,3-di-n-dodecylbarbituric acid, 1-n-octyl-3-n-octadecylbarbituric acid, 1-phenyl-3-(2,5-di-n-octyloxyphenyl)barbituric acid, 1-phenyl-3-methyl-5-pyrazolone, 1-(2,4,6-trichlorophenyl)-3-anilino-5-pyrazolone, 6-hydroxy-4-methyl-3-cyano-1- (2-ethylhexyl)-2-pyridone, 2-[3-[α-(2,4-di-t-amyl-phenoxy) butanamido]benzamido]phenol, 2,4-bis-(benzoylacetamino)toluene, 1,3-bis-(pivaloyl-acetaminomethyl)benzene, benzoylacetonitrile, thenoyl-acetonitrile, acetoacetanilide, benzoylacetanilide, pivaroylacetanilide, 2,5-di-n-heptyloxy-1-acetoacetamido-benzene, 2,5-di-n-butoxy-1-pivaroylacetamidobenzene, 2-chloro-5-(N-n-butylsulfamoyl)-1-pivaroylacetamidobenzene, 2′,5′-di-n-heptyloxybenzamide, and 1-(4-n-octyloxyphenyl)-3-t-butyl-5-aminopyrazole. These compounds are used within the range adapting to the object of the invention.

The coupler that is used in the invention may be used by solid-dispersing together with a water-soluble polymer, a basic substance and other color formation aid by a sand mill, or may be used as an emulsion with a proper emulsification aid. In this case, the preferable water-soluble polymer may be the water-soluble polymers that are used during the preparation of the microcapsules as described above (see, for example, JP-A No. 59-190886). The coupler, the basic substance, and the color formation aid are added to the water-soluble polymer solution such that each amount is from 5 to 40 % by mass. It is preferable that a particle size of the dispersed or emulsified particles is 10 μm or less.

In the invention, an organic base is added for the purpose of making the system basic during the thermal development to promote the coupling reaction. The organic base is disclosed in, for example, Japanese Patent Application No. 63-23490 and JP-A No. 1-63187.

The organic base may be used alone or in admixture of two or more thereof. Examples of the organic base include nitrogen-containing compounds such as tertiary amines, piperidines, piperazines, amidines, formamidines, pyridines, guanidines, and morpholines.

In particular, piperazines such as N,N′-bis (3-phenoxy-2-hydroxypropyl)piperazine, N,N′-bis[3-(p-methyl-phenoxy)-2-hydroxypropyl]piperazine, N,N′-bis[3-(p-methoxyphenoxy)-2-hydroxypropyl]piperazine, N,N′-bis(3-phenylthio-2-hydroxypropyl)piperazine, N,N′-bis[3-(β-naphthoxy)-2-hydroxypropyl]piperazine, N-3-(β-naphthoxy)-2-hydroxypropyl-N′-methylpiperazine, and 1,4-bis{[3-(N-methylpiperazino)-2-hydroxy]propyloxy} benzene; morpholines such as N-[3-(β-naphthoxy)-2-hydroxy]propylmorpholine, 1,4-bis{(3-morpholino-2-hydroxy)propyloxy} benzene, and 1,3-bis[(3-morpholino-2-hydroxy)propyloxy]benzene; piperidines such as N-(3-phenoxy-2-hydroxypropyl)piperidine and N-dodecylpiperidine; and guanidines such as triphenylguanidine, tricyclohexylguanidine, and dicyclohexylphenylguanidine are preferable.

In the invention, it is preferable that the coupler and the basic substance are used in amounts of from 0.1 to 30 parts by mass and from 0.1 to 30 parts by mass, respectively per part by mass of the diazonium compound.

In the case where the thermosensitive recording material according to the invention is a multilayered multi-color thermosensitive recording material, an interlayer may be provided for the purpose of avoiding the thermosensitive recording layers from color mixing with each other. The interlayer is made of a water-soluble polymer compound such as gelatin, phthalated gelatin, polyvinyl alcohol, and polyvinylpyrrolidone and may contain various additives. An application amount of the interlayer is preferably from 2 to 10 g/m², and more preferably from 4 to 5 g/m². A thickness of the interlayer is preferably from 0.5 to 10 μm.

### EXAMPLES

The present invention will be described in detail with reference to the following Examples, but the invention is not limited thereto. All “part” and “%” are on a mass basis unless otherwise indicated.

### Example 1

1) Preparation of electron donating colorless dye capsule liquid:

In 7.97 g of ethyl acetate was dissolved 3.23 g of 3-(o-acetylamino-p-dipropylaminophenyl)-3-(l-octyl-2-methylindole-3-yl)-4-azaphthalide (represented by the following formula) as an electron donating dye precursor, and 2.55 g of a solvent with a high boiling point (trade name: KMC-113, manufactured by Kureha Chemical Industry Co., Ltd.) was added to the resultant solution, followed by uniformly mixing. To the obtained mixed liquid (liquid X) was added 10.35 g of a capsule wall material (trade name: Takenate D119N, manufactured by Takeda Chemical Industries, Ltd.), and the resultant mixture was uniformly stirred. Separately, the liquid X was added to a mixture of 24.45 g of a 8% aqueous solution of #810 gelatin manufactured by Nitta Gelatin Inc., 4 g of water, and 0.04 g of Sucraph AG-8 (manufactured by Nippon Fine Chemical Co., Ltd.), and the resultant mixture was subjected to emulsification and dispersion by using a homogenizer at 40° C. and at a revolution number of 7,500 rpm for 7 minutes, to obtain an emulsion. To this emulsion were added 21.25 g of water and 0.05 g of tetraethylenepentamine, and the resultant mixture was stirred at 40° C. for 3 hours to cause encapsulation reaction. A desired capsule liquid was thus prepared. Incidentally, the microcapsules in the capsule liquid had a mean particles size of about 1.2 μm.

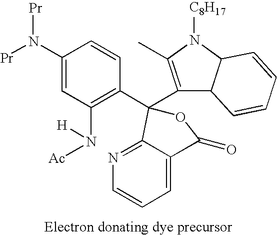

2) Preparation of Electron Accepting Compound Dispersion:

To 4 g of zinc 3,5-di-α-methylbenzyl-salicylate as an electron accepting compound were added 3 g of a 8% aqueous solution of phthalated gelatin, 13.3 g of water, and 1 g of a 2% of aqueous solution of sodium 2-ethylhexylsulfosuccinate, and the resultant mixture was dispersed for 24 hours by a sand mill, to obtain a desired electron accepting compound dispersion. The particles of the electron accepting compound in the dispersion had a mean particle size of 1.2 μm.

3) Preparation of Thermosensitive Recording Layer Coating Liquid:

The electron donating colorless dye capsule liquid and the electron accepting compound dispersion were mixed with each other in a mass ratio of the electron donating dye precursor to the electron accepting compound of 1/10. A desired thermosensitive recording layer coating liquid was thus prepared.

The coating liquid was applied to a support for photographic printing paper comprising wood-free paper having polyethylene laminated thereon by using a wire bar and then dried. A thermosensitive recording material (1) of the invention was thus prepared.

### Example 2

A thermosensitive recording material (2) of the invention was prepared in the same manner as in Example 1, except that in the preparation of electron accepting compound dispersion, the electron accepting compound was changed to zinc 3,5-di-α,α-dimethylbenzyl-salicylate (4 g)

### Example 3

A thermosensitive recording material (3) of the invention was prepared in the same manner as in Example 1, except that in the preparation of electron accepting compound dispersion, the electron accepting compound was changed to zinc 3,5-di-t-butyl-salicylate (4 g).

### Example 4

A thermosensitive recording material (4) of the invention was prepared in the same manner as in Example 1, except that in the preparation of electron accepting compound dispersion, the electron accepting compound was changed to zinc 3-dodecyl-salicylate (4 g).

### Example 5

A thermosensitive recording material (5) of the invention was prepared in the same manner as in Example 1, except that in the preparation of electron accepting compound dispersion, the electron accepting compound was changed to zinc 3-1,1,3,3-tetramethylbutyl-salicylate (4 g).

### Comparative Example 1

A thermosensitive recording material (6) for comparison was prepared in the same manner as in Example 1, except that in the preparation of electron accepting compound dispersion, the electron accepting compound was changed to bisphenol A (4 g).

### Comparative Example 2

A thermosensitive recording material (7) for comparison was prepared in the same manner as in Example 1, except that the electron donating colorless dye capsule liquid in Example 1 was replaced by an electron donating dye precursor solid dispersion having the following formulation.

Preparation of Electron Donating Dye Precursor Solid Dispersion

To 1.5 g of 3- (o-acetylamino-p-dipropylaminophenyl)-3-(1-octyl-2-methylindole-3-yl)-4-azaphthalide (represented by the following formula) as an electron donating dye precursor were added 5.63 g of a 8 % aqueous solution of phthalated gelatin, 12.08 g of water, and 0.38 g of a sodium 2-ethylhexylsulfosuccinate aqueous solution, and the resultant mixture was dispersed for 24 hours by a sand mill, to obtain a desired electron donating dye precursor solid dispersion.

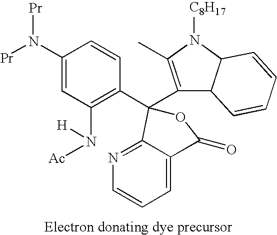

<Image Recording>

Cyan images were thermally printed on each of the obtained thermosensitive recording materials (1) to (5) of the invention and thermosensitive materials (6) and (7) for comparison with a thermal head (manufactured by Kyocera Corporation), to form a cyan image.

<Evaluation>

1. Light Fastness Test of Image Areas:

The light fastness (image retention rate) of the thermosensitive recording materials was measured in the following manner.

Color formation densities of each thermosensitive recording material after imagewise recording were measured with a densitometer (trade name: X-RITE, manufactured by X-Rite Incorporated) to specify a portion where a cyan density was 1.0 and then each thermosensitive recording material was irradiated with a xenon light (for 24 hours and 72 hours) by a weather-o-meter (Xe lamp) manufactured by The Atlas Electric Devices Co. With respect to each of the thermosensitive recording materials after the irradiation, a color formation density in the specified portion was again measured, and then an image retention rate was calculated.

2. Color Formation Density of Image Areas:

With respect to each thermosensitive recording material having a cyan image formed thereon, a maximum color formation density of image areas immediately after imagewise recording was measured with a densitometer (trade name: X-RITE, manufactured by X-Rite Incorporated).

The results obtained are shown in Table 1.

TABLE 1

| | Light fastness of | Light fastness of | Maximum color |
|---|---|---|---|
| | image areas/24 hr | image areas/72 hr | formation density |
| Example 1 | 90% | 65% | 1.90 |
| Example 2 | 95% | 60% | 1.85 |
| Example 3 | 88% | 62% | 1.86 |
| Example 4 | 87% | 63% | 1.75 |
| Example 5 | 91% | 64% | 1.72 |
| Comparative | 72% | 48% | 2.02 |
| Example 1 | | | |
| Comparative | 75% | 53% | 2.05 |
| Example 2 | | | |

As is clear from Table 1, it is understood that the thermosensitive recording materials of the invention are superior in color formation density. The maximum color formation density in Examples 1, 2 and 3 is equivalent to that in Comparative Examples 1 and 2; and though the maximum color formation density in Examples 4 and 5 is slightly low, it is in a practical level.

Further, it is understood that the thermosensitive recording materials of the invention are superior in light fastness in image areas as compared with those of Comparative Examples 1 and 2. In particular, as shown in the results of Example land Comparative Example 2, it was confirmed that even in the case where the same electron donating dye precursor was used, the thermosensitive recording material of the invention, in which the electron donating dye precursor was encapsulated in microcapsules, is extremely superior in light fastness in image areas to the thermosensitive recording material for comparison, in which the electron donating dye precursor was used as a dispersion.

What is claimed is:

1. A thermosensitive recording material comprising: a support; and a thermosensitive recording layer containing, as color forming components, an electron donating dye precursor encapsulated in microcapsules and an electron accepting compound, the electron accepting compound containing a salicylic acid metal salt represented by the following General Formula (1): 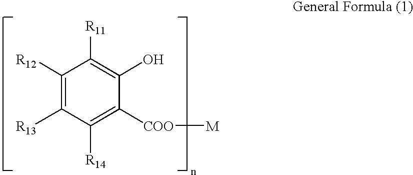
wherein R₁₁, R₁₂, R₁₃, and R₁₄ independently represent one of a hydrogen atom, a halogen atom, an alkyl group, an aryl group, an alkoxy group, an aryloxy group, an alkylthio group, an arylthio group, an alkylsulfonyl group, an arylsulfonyl group, an alkoxycarbonyl group, an aryloxycarbonyl group, an acyloxy group, an acyl group, a carbamoyl group, a sulfamoyl group, a sulfonamide group, a cyano group, and a nitro group; two adjacent groups in R₁₁ to R₁₄ may bond to each other to form a ring; M represents a metal ion having a valence of n; and n represents an integer of from 1 to 3.

2. The thermosensitive recording material according to claim 1, wherein the metal ion M in the General Formula (1) is a zinc ion.

3. The thermosensitive recording material according to claim 1, wherein the microcapsules comprise, as the capsule wall component, a polymer formed by polymerizing an isocyanate compound represented by the following General Formula (2): 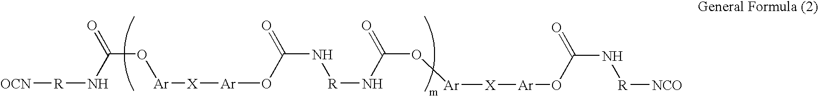
wherein Ar represents an arylene group; X represents a single bond or a divalent connecting group; R represents one of an alkylene group, an aralkylene group, and an arylene group; and m represents an integer of from 0 to 20.

4. The thermosensitive recording material according to claim 3, wherein the metal ion M in the General Formula (1) is a zinc ion.

5. The thermosensitive recording material according to claim 1, wherein the salicylic acid metal salt represented by the General Formula (1) is in a solid dispersed state.

6. The thermosensitive recording material according to claim 2, wherein the salicylic acid metal salt represented by the General Formula (1) is in a solid dispersed state.

7. The thermosensitive recording material according to claim 3, wherein the salicylic acid metal salt represented by the General Formula (1) is in a solid dispersed state.

8. The thermosensitive recording material according to claim 1, wherein the electron donating dye precursor is a compound represented by the following General Formula (3): 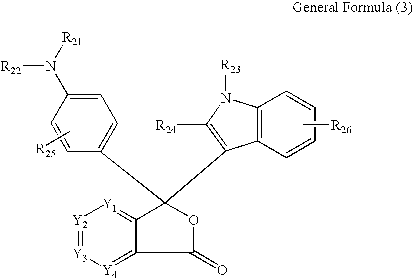
wherein R₂₁ and R₂₂ independently represent one of a hydrogen atom, an alkyl group, a cycloalkyl group, an aralkyl group, and an aryl group, provided that R₂₁ and R₂₂ do not represent a hydrogen atom simultaneously; R₂₃ represents one of a hydrogen atom, an alkyl group, a cycloalkyl group, an aralkyl group, and an aryl group; R₂₄ represent one of a hydrogen atom, an alkyl group, and an aryl group; R₂₅ and R₂₆ independently represent one of a hydrogen atom, an alkyl group, an alkoxy group, an amide group, an alkylamide group, and a halogen atom; and one or two of Y₁, Y₂, Y₃, and Y₄ represents ═N—, and the others represent ═CH—.

9. The thermosensitive recording material according to claim 8, wherein the metal ion M in the General Formula (1) is a zinc ion.

10. The thermosensitive recording material according to claim 8, wherein the microcapsules comprise, as the capsule wall component, a polymer formed by polymerizing an isocyanate compound represented by the following General Formula (2): 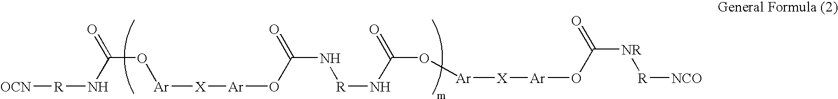
wherein Ar represents an arylene group; X represents one of a single bond and a divalent connecting group; R represents one of an alkylene group, an aralkylene group, and an arylene group; and m represents an integer of from 0 to 20.

11. The thermosensitive recording material according to claim 8, wherein the salicylic acid metal salt represented by the General Formula (1) is in a solid dispersed state.

12. The thermosensitive recording material according to claim 1, wherein the salicylic acid metal salt represented by the General Formula (1) is zinc 3,5-α-methylbenzyl-salicylate.

13. The thermosensitive recording material according to claim 1, wherein the salicylic acid metal salt represented by the General Formula (1) is zinc 3,5-α,α-dimethylbenzyl-salicylate.

14. The thermosensitive recording material according to claim 1, wherein the salicylic acid metal salt represented by the General Formula (1) is zinc 3,5-t-butylsalicylate.

15. The thermosensitive recording material according to claim 1, wherein the salicylic acid metal salt represented by the General Formula (1) is zinc 3-dodecylsalicylate.

16. The thermosensitive recording material according to claim 1, wherein the salicylic acid metal salt represented by the General Formula (1) is zinc 3-1,1,3,3-tetramethylbutyl-salicylate.

17. The thermosensitive recording material according to claim 1, wherein the electron accepting compound further contains at least one member selected from the group consisting of phenol compounds, triphenylmethane compounds, sulfur-containing phenol compounds, carboxylic acid compounds, sulfone compounds, ureas, and thiourea compounds.

18. The thermosensitive recording material according to claim 17, wherein an amount of said at least one member included is from 10 to 100 parts by mass based on 100 parts by mass of the salicylic acid metal salt represented by the General Formula (1).

19. The thermosensitive recording material according to claim 1, wherein an amount of the electron accepting compound included is from 0.5 to 50 parts by mass per part by mass of the electron donating dye precursor.

20. The thermosensitive recording material according to claim 1, wherein an amount of the electron accepting compound included is from 1 to 20 parts by mass per part by mass of the electron donating dye precursor.
